(19) United States
(12) Patent Application Publication
(10) Pub. No.: US 2026/0076288 A1
(43) Pub. Date: Mar. 19, 2026

(54) SEED DRILL CALIBRATION DEVICE AND METHOD

(71) Applicant: Great Plains Manufacturing, Inc., Salina, KS (US)

(72) Inventors: Michael Dane Haverfield, Smolan, KS (US); Craig Allen Reed, Salina, KS (US); Rye DeGarmo, Salina, KS (US); Benjamin Carrol Houghton, Gypsum, KS (US); Gregory W. Arnett, Garden City, MO (US)

(21) Appl. No.: 18/885,110

(22) Filed: Sep. 13, 2024

(51) Int. Cl. A01C 7/10

(52) U.S. Cl. CPC A01C 7/107

(57) ABSTRACT

A calibration device and method for calibrating, via a handheld drill, a seed drill having a calibration shaft. The calibration device comprises a housing, an input shaft, a transmission, and an output shaft. The input shaft and output shaft extend from opposite sides of the housing. The transmission drivably connects the input shaft to the output shaft so that rotation of the input shaft results in rotation of the output shaft. The output shaft is configured to drivably engage the calibration shaft. The input shaft is configured to be actuated via the handheld drill.

### FIELD OF THE INVENTION

Embodiments of the present invention are directed generally to auxiliary devices for agricultural implements for seeding. In more detail, embodiments of the present invention are directed to auxiliary devices for agricultural implements that include seed metering devices for dispensing seed and/or other agricultural products.

### BACKGROUND OF THE INVENTION

Certain agricultural implements, such as seed drills, are configured to dispense agricultural products (e.g., seed and/or treatment) into or onto the ground. Commonly, a seed drill will include one or more bins that hold agricultural product. As the seed drill is pulled through a field by a tractor or other prime mover, agricultural product can be dispensed from the bins via a plurality of metering devices associated with the bins.

Metering devices must be calibrated according to seed type and planting considerations such as local climate, field conditions, and budget. Some metering devices are driven by an electronic control unit (ECU) controlled hydraulic drive, which provide automatic calibration capabilities. Other metering devices are ground driven and must be manually calibrated. This entails determining several metering device and drive train settings according to a multitude of factors such as seed size and desired spacing, and adjusting the agricultural implement according to the settings. Manual calibration further entails hand-cranking a calibration shaft so the metering devices dispense seeds, while mentally or manually tracking calibration shaft rotations. This is fatiguing and often leads to calibration errors. Hand-cranking speed may also be overly fast or slow, leading to reduced calibration accuracy because seeds are not dispensed from the metering devices in a realistic manner.

### SUMMARY OF THE INVENTION

In one embodiment of the present invention, there is provided a calibration device for calibrating, via a handheld drill, a seed drill having a calibration shaft. The calibration device comprises a housing, an input shaft, a transmission, and an output shaft. The input shaft and output shaft extend from opposite sides of the housing. The transmission drivably connects the input shaft to the output shaft so that rotation of the input shaft results in rotation of the output shaft. The output shaft is configured to drivably engage the calibration shaft. The input shaft is configured to be actuated via the handheld drill.

In another embodiment of the present invention, there is provided a method of calibrating a seed drill having a calibration shaft. The method comprises steps of drivably connecting an output shaft of a calibration device to the calibration shaft and drivably connecting a chuck of a handheld drill to an input shaft of the calibration device. The method further comprises a step of activating the handheld drill to turn the calibration shaft via the calibration device.

In yet another embodiment of the present invention, there is provided a calibration device for calibrating, via a rotational tool such as a handheld drill having a chuck, a seed drill having a calibration shaft. The calibration device comprises a housing, an input shaft, a transmission, an output shaft, a digital counter, at least one of a processor and an electronic circuit, an electronic display screen, a selection input, and a reset input. The input shaft extends from the housing and includes a section shaped for being engaged by the chuck or another rotational tool. The transmission is a planetary gear system drivably connected to the input shaft. The output shaft extends from an opposite side of the housing relative to the input shaft and is drivably connected to the transmission so that rotation of the input shaft results in rotation of the output shaft. The output shaft is configured to drivably engage the calibration shaft. The digital counter is configured to track a turn count of the output shaft. The electronic display screen is configured to display the turn count of the output shaft. The selection input allows a user to select display information. The reset input allows the user to reset the turn count.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE FIGURES

Embodiments of the present invention are described herein with reference to the following drawing figures, wherein:

FIG. 1 is a top perspective view of an agricultural implement according to embodiments of the present invention;

FIG. 2 is another top perspective view of the agricultural implement of FIG. 1;

FIG. 3 is a bottom perspective view of the agricultural implement of FIG. 1;

FIG. 4 is an enlarged perspective view of certain components of the agricultural implement of FIG. 1 and a calibration device according to embodiments of the present invention;

FIG. 5 is a cutaway side elevation view of certain components of the agricultural implement of FIG. 1;

FIG. 6 is a perspective view of the calibration device of FIG. 4;

FIG. 7 is a front elevation view of the calibration device of FIG. 4;

FIG. 8 is a bottom perspective view of the calibration device of FIG. 4;

FIG. 9 is a rear elevation view of the calibration device of FIG. 4;

FIG. 10 is a cutaway perspective view of the calibration device of FIG. 4;

FIG. 11 is an exploded perspective view of certain components of the calibration device of FIG. 4;

FIG. 12 is a schematic diagram of certain components of the calibration device of FIG. 4; and

FIG. 13 is a flow diagram of certain method steps in accordance with other embodiments of the invention.

1The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the present invention references various embodiments. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

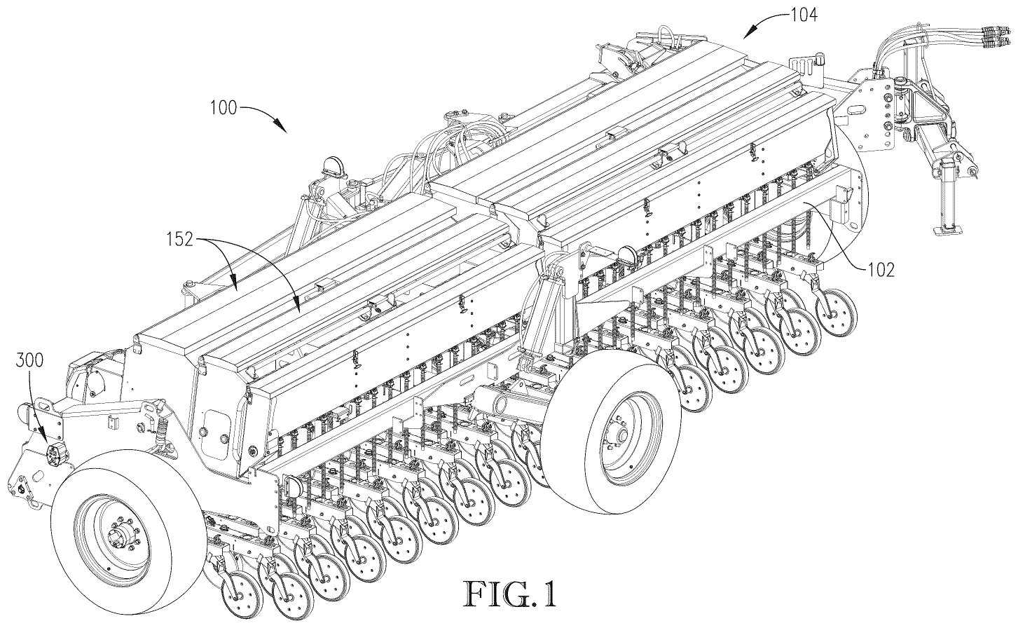

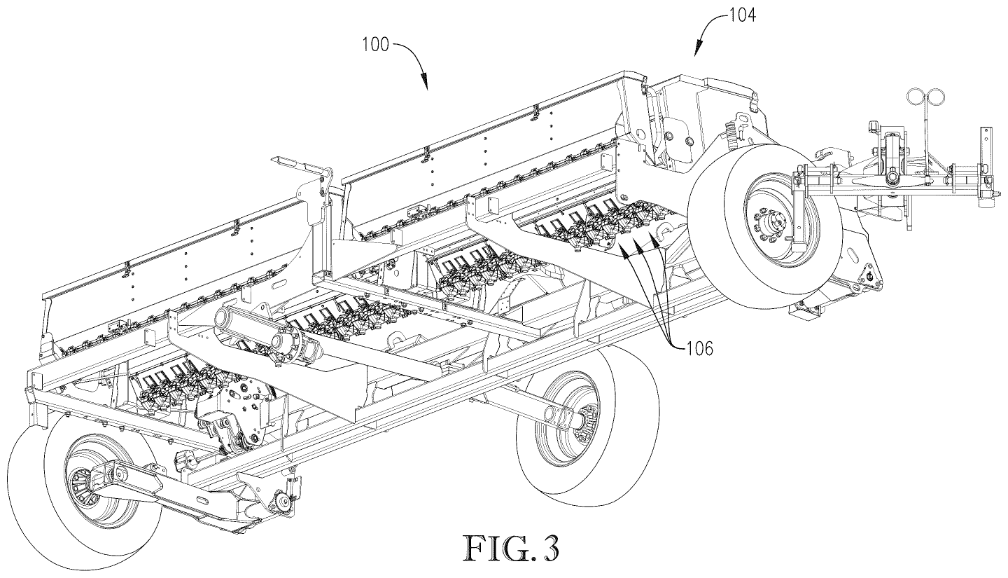

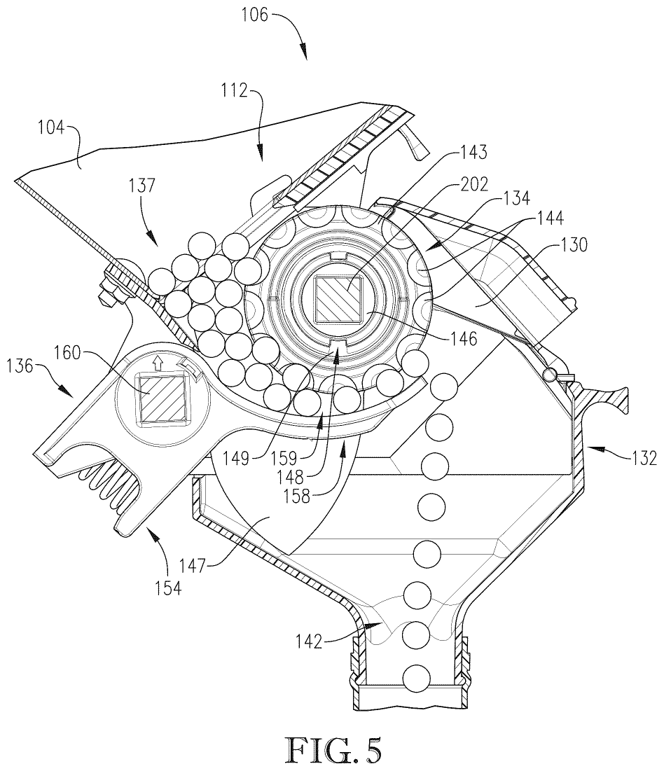

Turning to FIGS. 1-3, embodiments of the present invention are directed generally to auxiliary devices, and particularly a calibration device 300 described below and initially illustrated in FIG. 1, for use with agricultural implements such as a seed drill 100. The seed drill 100 may comprise a frame 102 that is towed by a tractor or other prime mover (not shown). The frame 102 may support a bin 104 configured to hold agricultural products, such as seed and/or treatment (e.g., fertilizer, pesticides, etc.), for dispensing into and/or onto the ground. In some embodiments, the bin 104 may be divided into multiple containment sections 152 that are each configured to hold distinct types of agricultural product. For instance, the bin 104 may include a forward containment section and a rearward containment section. As such, the forward containment section may be configured to hold a first type of agricultural product (e.g., seed), while the rearward containment section may be configured to hold a second type of agricultural product (e.g., treatment). As used herein, the term “treatment” may refer to fertilizers, pesticides, herbicides, nutrients, or other additives used in connection with seeding. Bottom sections of the bin 104 may be formed in a triangular or funnel shape. Each bottom section may include a plurality of product openings 112 (FIG. 5).

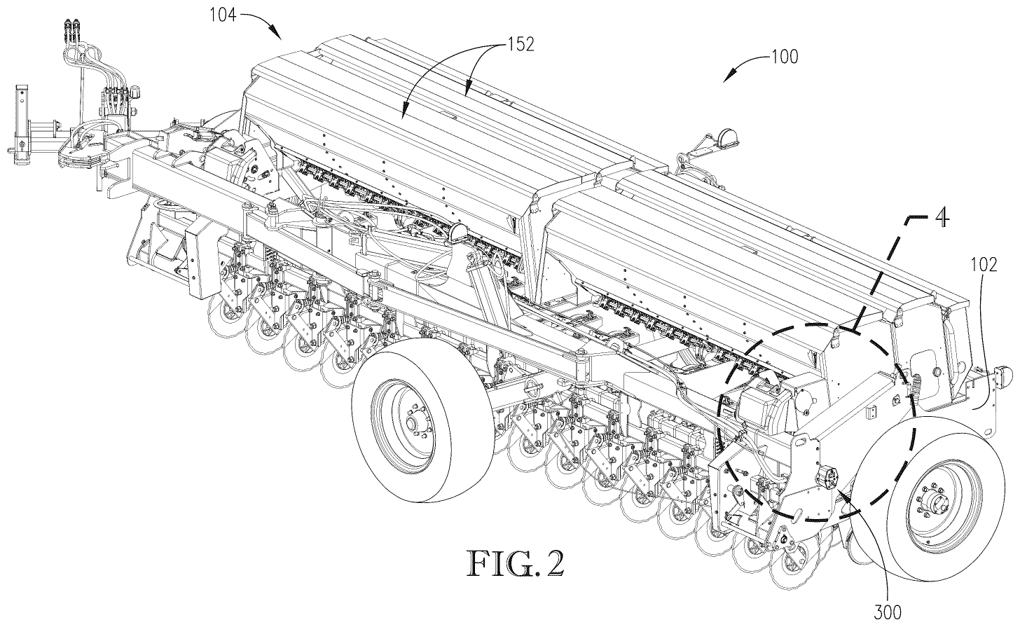

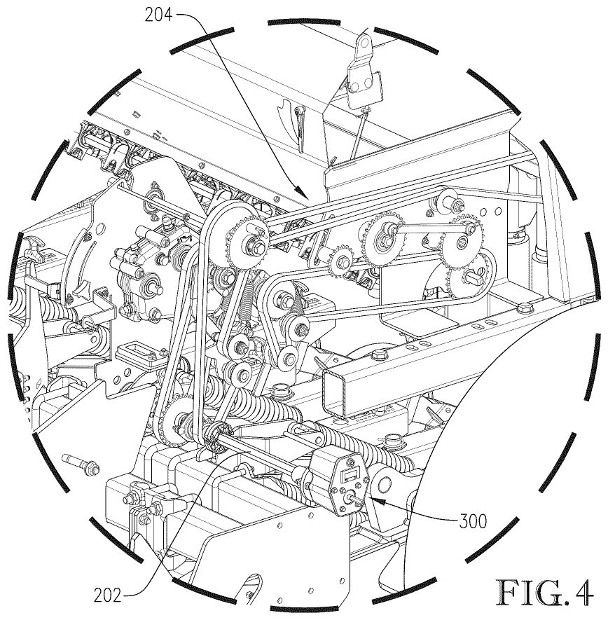

To facilitate dispensing of agricultural product, the seed drill 100 may additionally comprise a plurality of metering devices 106 secured to a bottom side of the bin 104, such as illustrated in FIG. 2. Different subsets of metering devices 106 may be secured to a bottom of each containment section. The metering devices 106 may be driven via a ground drive system 204, such as the one shown in FIG. 4. To that end, the ground drive system 204 may include belts and sheaves, chains and sprockets, gears, and the like. The ground drive system 204 may also include a calibration shaft 202 for calibrating the seed drill 100 as discussed in more detail below.

Agricultural product held within the bin 104 may be funneled downward under the force of gravity towards the product openings 112, such that the agricultural product can pass through the product openings 112 to the metering devices 106 that function to dispense the agricultural product from the bin 104 into or onto the ground. To promote efficient funneling and mixing of the agricultural product within the bin 104, some embodiments may provide for the bin 104 to include a mixing assembly (not shown) extending through the interior space of the bin 104. Such mixing assemblies may include a rotatable shaft that extends through a length of the bin 104 and includes a plurality of mixing arms extending therefrom. Embodiments may provide for the rotatable shaft to be rotated in different directions and/or at different rotational speeds. Alternatively, the rotatable shaft may rotate at a generally constant speed and direction. Regardless, rotation of the rotatable shaft will cause the mixing arms to mix the agricultural product within the bin 104 so as to ensure proper mixing, funneling, and flow of the agricultural product through the bin 104. In some additional embodiments, oscillators and/or agitators may be used to ensure proper mixing, funneling, and flow of the agricultural product through the bin 104.

Turning now to the metering devices 106 in more detail, as illustrated in FIG. 5, each metering device 106 may comprise an upper housing 130, a lower housing 132 removably engaged with the upper housing 130, a metering assembly 134 removably secured within an interior of the upper and/or lower housing 130, 132, and a gate assembly 136 removably secured within an interior of the upper and/or lower housing 130, 132. In operation of the seed drill 100, a plurality of the metering devices 106 may be secured to an exterior bottom surface of the bin 104. Thus, agricultural product can be passed from the bin 104 to the metering device 106, such that the metering assembly 134 can convey the agricultural product through the metering device 106 and out of the metering device 106 where the agricultural product is dispensed into or onto the ground.

The upper housing 130 may present a product inlet 137 through selective opening of product doors (not shown) slidingly engaged with the top end of the upper housing 130. Each of the product doors can be slidingly actuated between a closed position and an open position. In a closed position, the product doors restrict agricultural product from entering the metering device 106. In contrast, in an open position, the product doors permit agricultural product to enter the metering device 106 via the presented product inlet 137. In some embodiments, each of the product doors can be partially opened to various levels of extension (i.e., positions between completely closed and completely open) so as to regulate how much agricultural product can be provided into the metering device 106.

As will be described in more detail below, the interior space of the metering device 106 may be divided into two agricultural product sections (e.g., a first agricultural product section and a second agricultural product section), such that two different types of agricultural product can be separately processed through the metering device 106. To facilitate such separate processing, the product doors can be individually actuated. For instance, in order to supply a first agricultural product from the bin 104 to the metering device 106, a first one of the product doors can be opened and a second one of the product doors can be closed so that the first agricultural product can be passed from the bin 104 to the interior space of the metering device 106 via the product unlet 137 presented by the opened first product door. In contrast, to supply a second agricultural product from the bin 104 to the metering device 106, the second product door can be opened, and the first product door can be closed. As such, the second agricultural product can be passed from the bin 104 to the interior space of the metering device 106 via the product inlet 137 presented by the opened second product door.

Upon agricultural product being received into the upper housing 130 of the metering device 106, via the product inlet 137 presented by either the first product door or second product door, the agricultural product can be conveyed through metering device 106, via the metering assembly 134. By way of such conveyance, the agricultural product can be dispensed from the lower housing 132 via a product outlet 142. As illustrated in the drawings, the lower housing 132 may be shaped generally as a funnel with an upper end secured to the upper housing 130 and the product outlet 142 positioned a bottom end of the lower housing 132. As such, agricultural product can be dispensed from the metering device 106 via the product outlet 142 of the lower housing 132.

Embodiments provide for the metering devices 106 to convey various types of agricultural products. To facilitate such conveyances, the metering assembly 134 of the metering device 106 may comprise a plurality of metering wheels (e.g., metering wheel 143), each being particularly configured to convey a particular type of agricultural product. As noted previously, the metering assembly 134 may be removable from the upper and lower housings 130, 132.

The metering assembly 134 may comprise a sub-shaft 146, the metering wheels 143 positioned on the sub-shaft 146, and a divider 147 positioned on the sub-shaft 146 between the metering wheels 143. The sub-shaft 146 may comprise an elongated, hollow cylinder with an interior passageway having a surface shaped to conform to an exterior surface of a meter shaft discussed in more detail below. To facilitate rotation of the metering wheels 143, an exterior surface of the sub-shaft 146 may be formed with one or more longitudinally-extending grooves or keyways 148 to secure the metering wheels 143 onto the sub-shaft 146 such that rotation of the sub-shaft 146 will cause a corresponding rotation of the metering wheels 143.

The metering wheels 143 may each comprise a hollow interior section and a fluted exterior section. The interior section may include one or more protrusions or keys 149, which are configured to be received in the grooves of the sub-shaft 146 when aligned. As such, the metering wheels 143 may be slid onto the sub-shaft 146 and secured in place via engagement between the keys 149 (of the metering wheels 143) and the keyways 148 (of the sub-shaft 146), such that rotation of the sub-shaft 146 will cause a corresponding rotation of the metering wheels 143. The exterior sections of each of the metering wheels 143 may include a number of flutes 144 or concave grooves within which agricultural product (e.g., seed or treatment) can be received or captured for rotation through the metering device 106. The size of the flutes 144 of each metering wheel 143 can vary depending on the type and size of the agricultural product intended to be processed by the metering device 106.

In addition to the metering assembly 134, certain embodiments of the present invention will provide for the metering device 106 to include gate assembly 136. The gate assembly 136 may comprise a product gate 154 having an elongated, arcuate gate valve 158. When installed within the metering device 106 during operation, the gate valve 158 will be spaced below the metering wheels 143 so as to provide a product channel 159 through which agricultural product can be conveyed by the metering wheels 143. The size of the channel 159 can be adjusted by adjusting a position of the gate valve 158 with respect to the metering wheels 143. For instance, shifting the gate valve 158 downward will create a larger channel 159. Such a larger channel 159 may be preferable when using the metering device 106 to dispense relatively large agricultural products from the bin 104 (e.g., large seeds). Alternatively, shifting the gate valve 158 upward towards the metering wheels 143 will create a smaller channel 159. Such a smaller channel may be preferable when using the metering device 106 to dispense relatively small agricultural products from the bin 104 (e.g., fine seeds). Ensuring the appropriate size of channel 159 for a given agricultural product will ensure consistent and accurate flow of such agricultural product through the metering device 106. In some embodiments, it may be preferable to reduce the product channel 159 to a minimum such that the gate valve 158 is forced upward into contact with the metering wheels 143.

The position of the gate valve 158 (and thus the size of the channel 159) can be shifted by an adjustment shaft 160, which can extend through each of the metering devices 106 of the seed drill 100. Specifically, the adjustment shaft 160 may extend through each of the gate assemblies 136 of the metering devices 106, such that rotation of the adjustment shaft 160 will cause a corresponding adjustment to the positions of each of the product gates 154, and particularly to the gate valve 158, with respect to the metering assemblies 134. The adjustment shaft 160 can be rotated by various components or methods. For instance, the adjustment shaft 160 may be connected to a handle or lever, which can be manually adjusted by an operator of the seed drill 100. The lever may be securely held in various positions, which correspond with the adjustment shaft 160 and/or the gate valve 158 being securely held in various positions. As was noted above, the gate valve 158 being positioned at various positions (e.g., further away from or closer to the metering wheels 143) will provide for the channel 159 to have a correspondingly larger or smaller size. It is noted that a single lever may be used to rotate the adjustment shaft 160, such that the positions of each of the gate valves 158 of the metering devices 106 through which the adjustment shaft 160 extends can be simultaneously adjusted. As an alternative to the lever, the adjustment shaft 160 may be connected to a motor or gear system, which can actuate the adjustment shaft 160 automatically or from a remote command provided by the operator of the seed drill 100 (e.g., from a cab of the tractor pulling the seed drill 100).

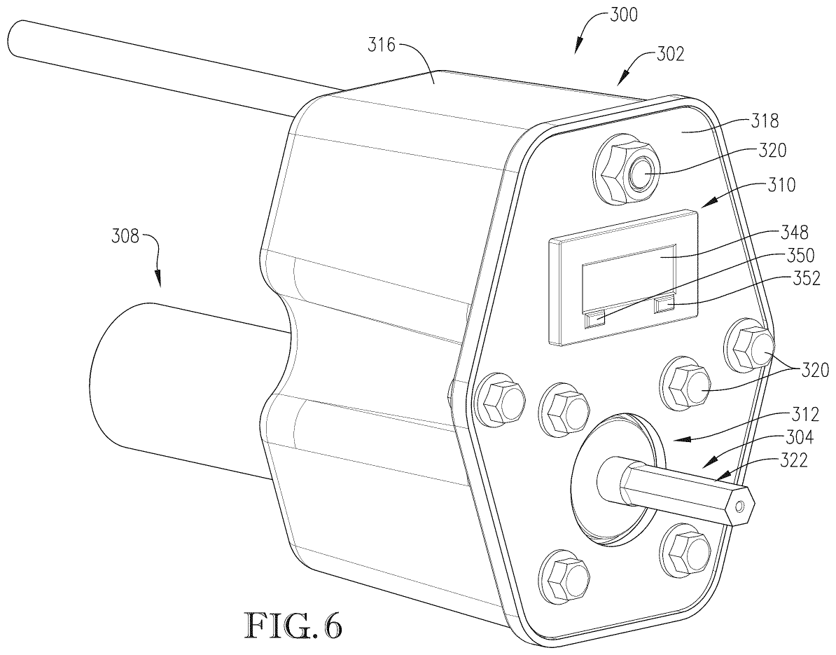

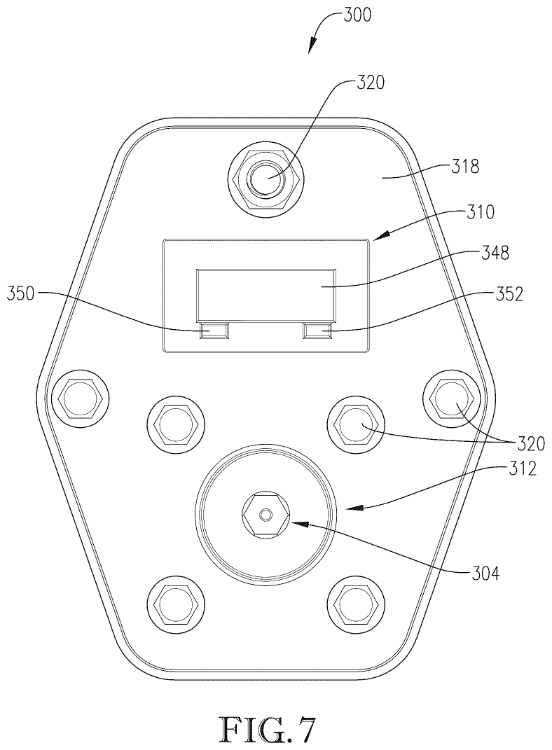

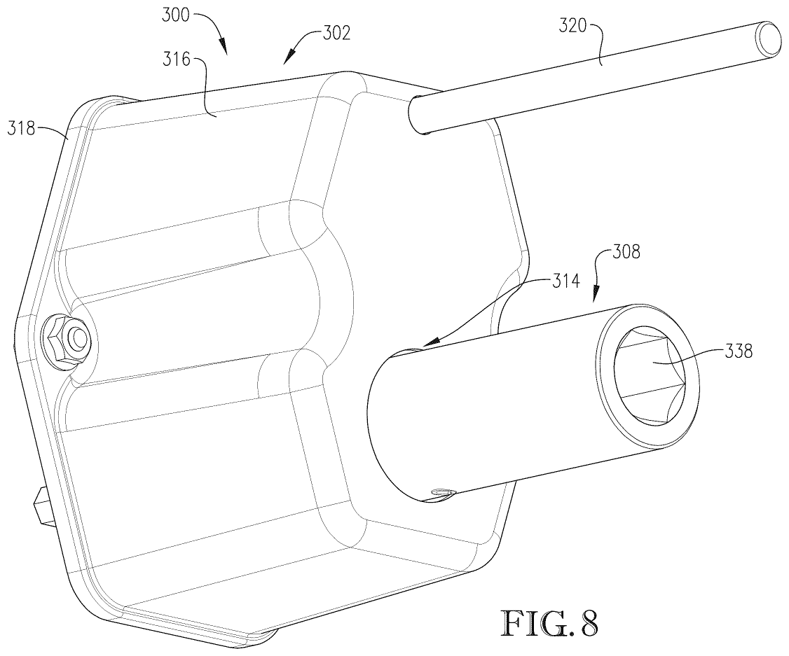

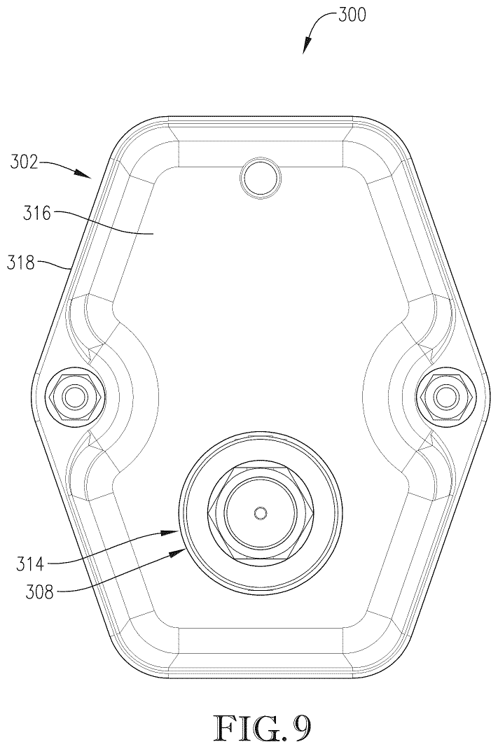

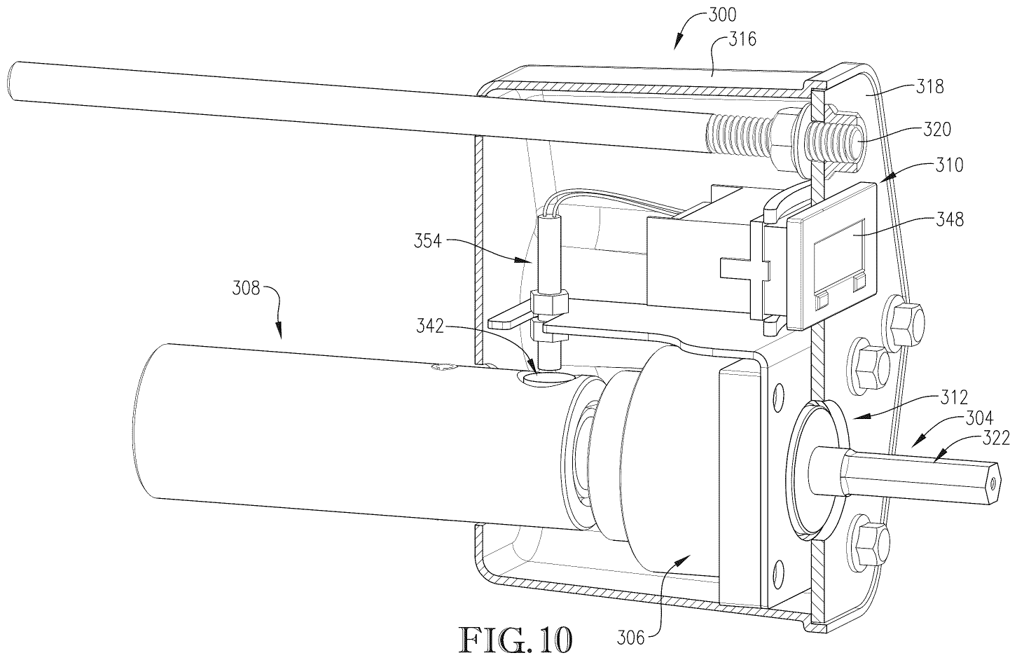

Turning to FIGS. 6-12, the calibration device 300 allows a user to calibrate the drill 100, and specifically the metering devices 106, to a desired seed rate. The calibration device 300 broadly comprises a housing 302, an input shaft 304, a transmission 306, an output shaft 308, and an information unit 310.

The housing 302 encloses the transmission 306 and includes a forward opening 312 for the input shaft 304 to extend therethrough and a rearward opening 314 for the output shaft 308 to extend therethrough. The housing 302 may also present a display screen of the information unit 310 (described below). In one embodiment, the housing 302 may include a shell 316 and a faceplate 318 secured to the shell 316 via fasteners 320. In such an embodiment, the shell 316 may include the aforementioned rearward opening 314, and the faceplate 318 may include the aforementioned forward opening 312. One or more of the fasteners 320 may be elongated for aligning the housing 302 with the drill 100 and/or attaching the housing 302 to the drill 100.

The input shaft 304 extends through the forward opening 312 from the housing 302 for being engaged by a chuck of a handheld drill. To that end, the input shaft 304 may include a hexagonal section 322 for interfacing with jaws of the chuck.

The transmission 306 drivably connects the input shaft 304 and the output shaft 308 via a reduction ratio. The transmission 306 may include inter-engaging gears (not shown) to achieve the reduction ratio. The gears may be or may include spur gears, worm gears, planetary gears, or the like. Alternatively, a set of belts and sheaves, chains and sprockets, or the like may be used. A combination of the aforementioned components may also be used. The transmission 306 may have a reduction ratio of greater than one to one such as two to one or three to one. The transmission 306 may have a single fixed reduction ratio or may be selectively reconfigurable between different gears or components to effect different reduction ratios. The transmission 306 may also be a variable transmission configured to effect reduction ratios within a range of reduction ratios such as between one to one and three to one. The transmission 306 also creates a mechanical advantage so that a relatively low torque of the handhell drill can produce a relatively greater torque on the calibration shaft 202, which may be required to overcome resistance of the many metering devices 106 driven by the calibration shaft 202.

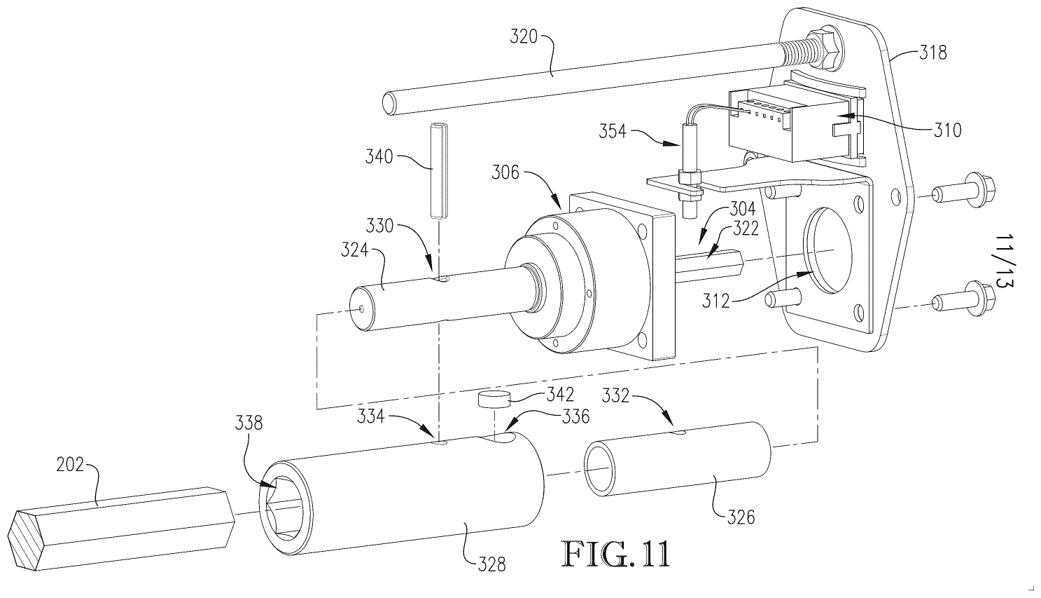

With particular reference to FIG. 11, the output shaft 308 may extend through the rearward opening 314 from the housing 302 for being drivably connected to the calibration shaft 202 of the drill 100. In one embodiment, the output shaft 308 extends from an opposite side of the housing 302 relative to the input shaft. In yet another embodiment, the output shaft 308 extends parallel to the input shaft 304. In a further embodiment, the output shaft 308 and the input shaft 304 are axially aligned with each other. The output shaft 308 may include a shaft core 324, an inner sleeve 326, and an outer sleeve 328. The output shaft 308 may also include a set screw, locking collar, quick-release collar, or the like (not shown) for securing the output shaft 308 and hence the calibration device 300 to the calibration shaft 202.

The shaft core 324 may be connected to the transmission 306 and may include a pinhole 330. The shaft core 324 may extend into the inner sleeve 326 such that the pinhole 330 aligns with a pinhole of the inner sleeve 326 for receiving a pin 340 therein. The pin 340 may have an interference fit with the pinholes 330, 332, 334 or ma be a set screw or any other suitable aligning feature.

The inner sleeve 326 may encircle the shaft core 324 and may include a pinhole 332. The pinhole 332 may align with the pinhole 330 of the shaft core 324 for rotationally and longitudinally mating the inner sleeve 326 to the shaft core 324.

The outer sleeve 328 may encircle the inner sleeve 326 and may include a pinhole 334, a magnet recess 336, and a hexagonal inner section 338. The pinhole 334 may align with the pinholes 330 and 332 for rotationally and longitudinally mating the outer sleeve 326 to the inner sleeve 326 and shaft core 324. The magnet recess 336 may receive a magnet 342 therein. The hexagonal inner section 338 may be configured to engage the calibration shaft 202 of the drill 100. Alternatively, the outer sleeve 328 may include an inner section having a different shape (such as circular with a flat region) for engaging the calibration shaft 202. This may be particularly useful for calibration shafts having alternative geometry.

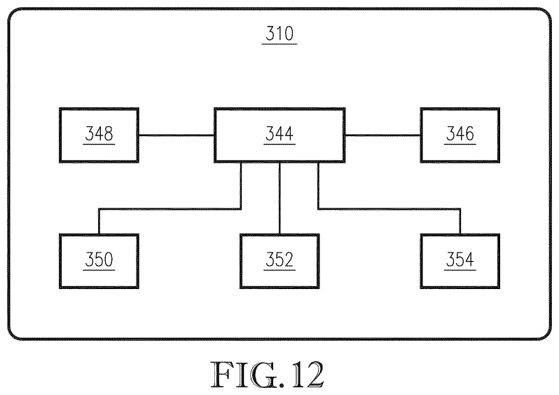

With particular reference to FIG. 12, the information unit 310 may embody a turn counter for tracking a turn count of the output shaft 308 and hence the calibration shaft 202 and a speed indicator (e.g., a tachometer) for monitoring rotational speed (e.g., rpms) of the output shaft 308 and hence the calibration shaft 202 or the input shaft 304. To that end, the information unit 310 may include a processor 344, a memory 346, a display screen 348, a selection input 350, a reset input 352, a circuit including a proximity sensor, Hall Effect sensor 354, or the like for detecting a position of the input shaft 304, output shaft 308, or one of the gears of shafts of the transmission 306.

The processor 344 may be configured to increase a turn count by one upon receiving a signal from the proximity sensor or Hall Effect sensor 354. The turn count may be stored in the memory 346. The processor 344 may also be configured to calculate an rpm of the input shaft 304 or output shaft 308 by counting a number turns per second multiplied by 60. This value may also at least briefly be stored in the memory 346.

The display screen 348 may be an LCD screen, “seven-segment display”, touch screen, or the like. The display screen 348 may display turn count, rpm, calibration run, transmission configuration, and/or other information as instructed by the processor 344.

The selection input 350 may be a button, a switch, or the like. Alternatively, the selection input 350 may be a graphical representation on the display screen 348 (in the case of a touch screen). Activating the selection input 350 may cause the display screen 348 to toggle between displaying the turn count, rpm, calibration run, transmission configuration, and other information. Alternatively or additionally, depending on context, activating the selection input 350 may initiate commands, select various modes, or turn the information unit 310 on or off.

The reset input 352 may also be a button, a switch, or the like. Alternatively, the selection input 350 may be a graphical representation on the display screen 348 (in the case of a touch screen). Activating the reset input 352 may cause the display screen 348 to reset the turn counter.

The Hall Effect sensor 354 may be mounted near the output shaft 308 so that the Hall Effect sensor 354 is configured to generate a signal when the magnet 342 nears or passes the Hall Effect sensor 354. Alternatively, a proximity sensor may be used to detect a geometric feature of the output shaft 308 and hence generate a signal representing a revolution thereof. The Hall Effect sensor 354 or proximity sensor may alternatively be mounted near the input shaft 304 or another rotational component. Simple calculations taking into account the reduction ratio of the transmission 306 may then be made via the information unit 310 to arrive at the rotational speed of the output shaft 308.

The information unit 310 may also be used to assist in setting up calibrations and the calibration device 300 itself. For example, a user may select a seed type, drill model, and/or other parameters. The information unit may, based on the user's inputs/selections, recommend metering device settings and drill settings. The information may also recommend calibration device configurations (for effecting an optimal reduction ratio and hence output shaft speed), and/or handheld drill configurations (for effecting an optimal output shaft speed).

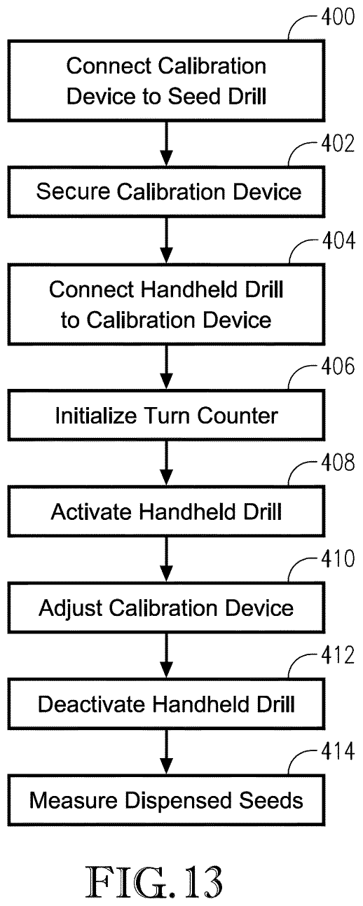

Turning to FIG. 13, a method of calibrating the seed drill 100 via the calibration device 300 will now be described in detail. First, the output shaft 308 of the calibration device 300 may be drivably connected to the calibration shaft 202 of the seed drill 100, as shown in block 400. The output shaft 308 may also be secured to the calibration shaft 202 via a set screw, a collar, or the like to prevent the output shaft 308 from becoming disconnected from the calibration shaft 202, as shown in block 402.

A handheld drill may then be drivably connected to the input shaft 304 of the calibration device 300, as shown in block 404. To that end, a chuck of the handheld drill may be tightened to engage the hexagonal section 322 of the input shaft 304.

The information unit 310 may always be on and thus may not need to specifically be turned on. To that end, the information unit 310 may be powered by a battery having a long (e.g., 15 year) battery life.

The turn counter may initialize to 0, as displayed on the display screen 348. However, if the turn counter is not at 0, the reset input 352 may be pressed to reset the turn counter to zero, as shown in block 406.

The handheld drill may then be activated thereby turning the calibration shaft 202 via the calibration device 300, as shown in block 408. The turn counter should track a turn count of the output shaft 308, and hence the calibration shaft 202 as the handheld drill operates. The speed indicator should also determine a current rpm of the input shaft 304 or the output shaft 308 (and hence the calibration shaft 202). The display screen 348 should display one of the turn count and the current rpm. These can be toggled via the selection input 350. If relying on turn count (e.g., for an embodiment that does not include rpm), a user may run the handheld drill at an appropriate speed to obtain the correct output speed. The user may use the turn count to represent an acre or fraction of an acre for which seed will be collected in order to calculate a seed per acre rate.

If the current rpm (as determined via rpm readout or manual calculation) is outside a desired or recommended range for accurate calibration, an rpm of the handheld drill can be changed by adjusting a setting or mode of the handheld drill. Alternatively, if the rpm of the handheld drill cannot be sufficiently altered, or if it is desired to not alter the rpm of the handheld drill, the reduction ratio of the calibration device 300 may be altered (in the case of a multi-speed or variable speed transmission), as shown in block 410. Specifically, the transmission can be adjusted to a different configuration (e.g., to a different “gear”) so that the rpm of the output shaft 308 and hence the calibration shaft 202 can be changed without altering the rpm of the handheld drill. If the transmission 306 is a variable transmission, the reduction ratio can be continuously changed until a desired rpm is reached. As yet another alternative, both the handheld drill may be adjusted and the calibration device 300 may be reconfigured if needed. Regardless, the current rpm (of the input shaft 304 or output shaft 308) can be viewed on the display screen 348 and adjustments, reconfigurations, or changes can be made until a desired rpm is achieved.

Once the calibration shaft 202 has turned a predetermined number of turns, as indicated by the turn counter, the handheld drill may then be deactivated or removed from the input shaft 304 of the calibration device 300 so the calibration shaft 202 stops turning, as shown in block 412.

The dispensed seeds may then be measured (e.g., weighed or volumetrically measured) to determine if the metering devices 106 are properly calibrated to dispense a desired amount of seeds over a desired area (i.e., a desired seed rate), as shown in block 414. If the measurement of dispensed seeds is too high, indicating the metering devices 106 are set to an excessive seed rate, the metering devices 106 may be adjusted to a lower seed rate. If the measurement of dispensed seeds is too low, indicating the metering devices 106 are set to a deficient seed rate, the metering devices 106 may be adjusted to a higher seed rate.

The above-described calibration device 300 and method provide several advantages. For example, a user may calibrate a ground-driven seed drill without hand-cranking the calibration shaft. The user may utilize a handheld electric drill, which is a ubiquitous tool and does not require additional training. Furthermore, the calibration device 300 implements a turn counter so the user does not have to track revolutions of the calibration shaft. The calibration device 300 also monitors rpms so appropriate settings can be used, thereby ensuring accurate calibrations.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

What is claimed is:

1. A calibration device for calibrating, via a handheld drill, a seed drill having a calibration shaft, wherein the calibration device comprises:
a housing;
an input shaft extending from the housing;
a transmission at least partially within the housing, the transmission being drivably connected to the input shaft; and
an output shaft extending from the housing, the output shaft being drivably connected to the transmission so that rotation of the input shaft results in rotation of the output shaft, the output shaft being configured to drivably engage the calibration shaft,
the input shaft being configured to be actuated via the handheld drill.

2. The calibration device of claim 1, wherein the handheld drill includes a chuck, and wherein the input shaft includes a hexagonal section configured to be engaged by the chuck.

3. The calibration device of claim 1, wherein the input shaft and the output shaft extend from opposite sides of the housing.

4. The calibration device of claim 1, wherein the input shaft and the output shaft are axially aligned with each other.

5. The calibration device of claim 1, further comprising a turn counter configured to track a turn count of the output shaft.

6. The calibration device of claim 1, wherein the turn counter is an electronic, digital turn counter.

7. The calibration device of claim 1, further comprising a speed indicator configured to indicate a rotational speed of at least one of the input shaft and the output shaft.

8. The calibration device of claim 1, wherein the speed indicator includes at least one of a processor and an electronic circuit configured to determine a rotational speed of at least one of the input shaft and the output shaft.

9. The calibration device of claim 1, further comprising an electronic display screen configured to display a turn count of the output shaft and a rotational speed of at least one of the input shaft and the output shaft.

10. The calibration device of claim 9, further comprising a selection input for selecting display information and a reset input for resetting a turn count.

11. The calibration device of claim 1, wherein the transmission is reconfigurable between a plurality of configurations each having a different reduction ratio.

12. The calibration device of claim 1, wherein the transmission is a variable transmission.

13. The calibration device of claim 1, wherein the transmission is a planetary gear system.

14. The calibration device of claim 1, wherein the output shaft is configured to be secured to the calibration shaft.

15. A method of calibrating a seed drill having a calibration shaft, the method comprising steps of:
drivably connecting an output shaft of a calibration device to the calibration shaft;
drivably connecting a chuck of a handheld drill to an input shaft of the calibration device; and
activating the handheld drill to turn the calibration shaft via the calibration device.

16. The method of claim 15, further comprising a step of changing a speed of the handheld drill so the output shaft turns within a predetermined rotational speed range as indicated by a display of the calibration device.

17. The method of claim 15, further comprising a step of changing a configuration of a transmission of the calibration device and hence a reduction ratio of the transmission, so the output shaft turns within a predetermined rotational speed range as indicated by a display of the calibration device.

18. The method of claim 15, further comprising a step of activating the handheld drill so the output shaft rotates a predetermined number of turns as indicated by a turn counter.

19. The method of claim 18, further comprising a step of resetting the turn counter before activating the handheld drill.

20. A calibration device for calibrating, via a handheld drill having a chuck, a seed drill having a calibration shaft, wherein the calibration device comprises:
a housing;
an input shaft extending from the housing, the input shaft including a hexagonal section for being engaged by the chuck of the handheld drill;
a transmission at least partially within the housing, the transmission being a planetary gear system and being drivably connected to the input shaft;
an output shaft extending from an opposite side of the housing relative to the input shaft, the output shaft being drivably connected to the transmission so that rotation of the input shaft results in rotation of the output shaft, the output shaft being configured to drivably engage the calibration shaft;
a digital counter configured to track a turn count of the output shaft;
an electronic display screen configured to display the turn count of the output shaft;
a selection input for selecting display information; and
a reset input for resetting the turn count.
